(19) United States
(12) Patent Application Publication
(10) Pub. No.: US 2012/0083842 A1
(43) Pub. Date: Apr. 5, 2012

(54) Pacifier Retaining Teething Strap that Attaches to a Child's Clothing

(75) Inventor: Betsy Barton, Miami, FL (US)

(73) Assignee: TOES FOR EYES INC, Miami, FL (US)

(21) Appl. No.: 13/252,280

(22) Filed: Oct. 4, 2011

Related U.S. Application Data
(60) Provisional application No. 61/404,507, filed on Oct. 5, 2010.

(51) Int. Cl. A61J 17/02

(52) U.S. Cl. 606/235

(57) ABSTRACT

Pacifier retaining straps that attach to a child's clothing and teething devices that attach to pacifiers are common as separate devices. Accordingly, the object of the present invention is to provide a combination pacifier retaining strap and teething device that attaches to a child's clothing wherein the strap itself is, and functions as, the teething device. The present invention is comprised of two parts including a strap constructed of a non-toxic, flexible material that purposefully and intentionally functions as a teething device with an integrated attachment system to retain a pacifier at the top end, and a clip to secure the pacifier retaining teething strap to a child's clothing on the opposing end.

### CROSS REFERENCE TO RELATED APPLICATIONS

This application claims the benefit of provisional patent application No. 61/404,507 filed on Oct. 5, 2010.

### FIELD OF THE INVENTION

The present invention pertains generally to infant and children's accessories, and more specifically to pacifier retaining straps that removably attach to a child's clothing.

### BACKGROUND OF THE INVENTION

Infants and young children enjoy sucking and chewing oral elements such as pacifiers and teething devices. During the developmental stage of teething, it is common for children to experience discomfort associated with such processes. The use of teething devices to alleviate such discomforts is well documented. Many infants and young children in this developmental stage use a pacifier to satisfy non-nutritional sucking needs.

For many years, varied methods of devices have been used to attach pacifiers to a child's clothing to prevent the child from losing or dropping the pacifier. A number of U.S. Patents related to non-retractable straps that removably attach to a child's clothing to retain a pacifier include: Guenther, U.S. Pat. No. 1,287,295; Lenoir, U.S. Pat. No. 3,392,729; Perry, U.S. Pat. No. 4,765,037; Huber, U.S. Pat. No. 4,903,698; Parsons, U.S. Pat. No. 4,972,980; Hooper, U.S. Pat. No. 4,985,968; Roberts, U.S. Pat. No. 4,990,157; Smith, U.S. Pat. No. 4,994,075 and Cohen, U.S. Pat. No. 5,150,504. Though the aforementioned pacifier retaining straps maybe constructed of a variety of materials, none claim the strap to purposefully and intentionally function as a teething device itself.

Attaching a device to an existing pacifier with the intent of adding a teething surface is not a new concept. Examples of this include the “teethable handle for infant pacifiers” (Johansen, U.S. Pat. No. 6,056,774), “infant blanket with teether/pacifier” (Dunn, U.S. Pat. No. 6,292,962) and “pacifier toy” (Jewett, U.S. Pat. No. 7,285,127). However, none of the aforementioned inventions attach to a child's clothing.

Several patents incorporate a nipple like mouthpiece referent of a pacifier attached to, or integrated into a teething device (Verschoor, U.S. Pat. No. 3,267,937; Janklow, U.S. Pat. No. 3,556,104; Grasset, U.S. Pat. No. 4,577,632). However, none of the aforementioned inventions attach to a child's clothing.

Thus, nowhere in the prior art is seen a combination pacifier retaining strap and teething device that attaches to a child's clothing wherein the object of the invention is such that the strap itself is, and functions as, the teething device.

### BRIEF SUMMARY OF THE INVENTION

The present invention is a combination pacifier retaining strap and teething device that attaches to a child's clothing wherein the strap itself is, and functions as, the teething device.

The present invention is comprised of two parts including a strap constructed of a non-toxic, flexible material that purposefully and intentionally functions as a teething device with an integrated attachment system to retain a pacifier at the top end, and a clip to secure the pacifier retaining teething strap to a child's clothing on the opposing end.

### BRIEF DESCRIPTION OF THE DRAWINGS

FIG. 1 illustrates a frontal view of one embodiment of the present invention.

FIG. 2 illustrates a side view of one embodiment of the pacifier engaging-end of the strap of the present invention.

FIG. 3 illustrates an alternate side view of one embodiment of the pacifier-engaging end of the strap of the present invention.

FIG. 4 illustrates an alternate elevated view of one embodiment of the pacifier-engaging end of the strap of the present invention.

FIG. 5 illustrates an elevated view of one embodiment of the present invention.

FIG. 6 illustrates a photograph of one embodiment of the present invention.

FIG. 7 illustrates an alternate photograph of one embodiment of the present invention.

### DETAILED DESCRIPTION OF THE INVENTION

A pacifier typically consists of a protruding nipple , shield and a knob, ring or hole that, serves to connect a pacifier retaining device or other such mechanism.

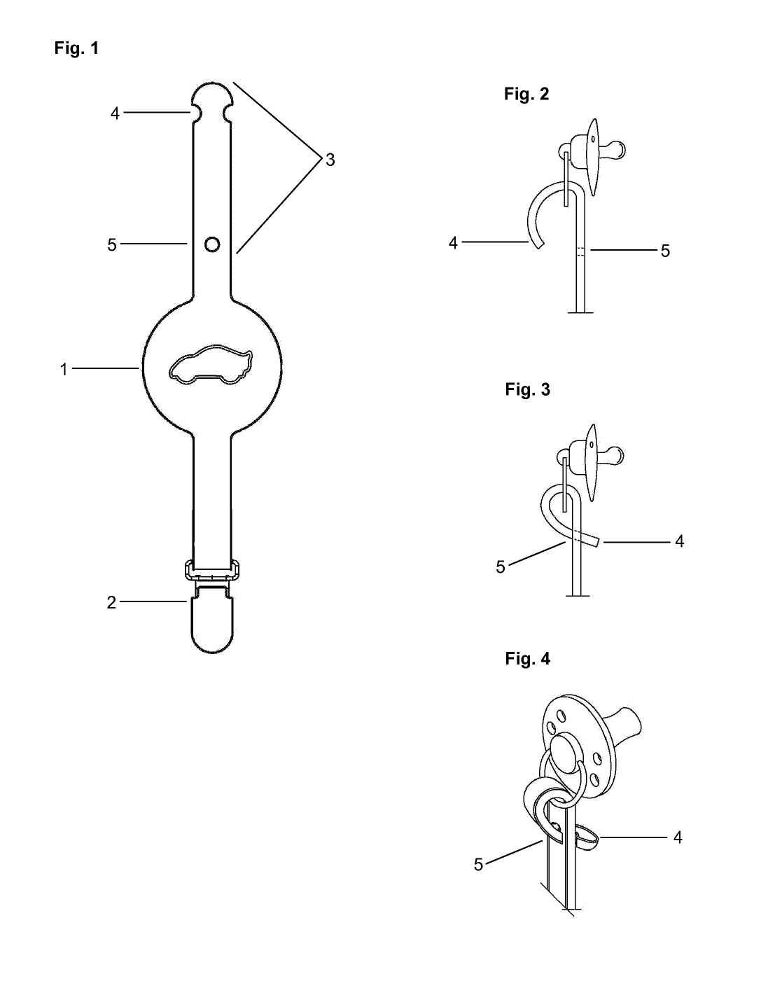

FIG. 1 is a frontal view of one embodiment of the present invention which is comprised of two parts including a strap (1) constructed of a non-toxic, flexible material that purposefully and intentionally functions as a teething device with an integrated attachment system to retain a pacifier at the top end, and a clip (2) to secure the pacifier retaining teething strap to a child's clothing on the opposing end.

Shown in FIG. 1, the preferred embodiment of the present invention consists of an integrated system (3) for attaching a ring-style pacifier or pacifier with a connection hole to the pacifier-engaging end of the strap (4).

The top of the pacifier-engaging-end of the strap (4) is positioned through the pacifier ring or fed through the connection hole of a pacifier. The top of the pacifier-engaging-end of the strap (4) is then looped around the pacifier ring or connection hole of the pacifier as shown in FIG. 2. The pacifier-engaging end of the strap (4) is then fed through the connection hole (5) of the strap (1) as illustrated in FIG. 3. FIG. 4 shows the pacifier-engaging end (4) of the strap (1) though the connection hole (5) of the strap (1) in the closed position.

The integrated pacifier attachment system (3) as detailed in FIGS. 2-4 eliminates the need for small components such as VELCRO or snaps which are not conducive to teething and may inadvertently detach posing a possible choking hazard.

The integrated pacifier attachment system (3) provides an additional teething surface when in the closed position as shown in FIG. 4.

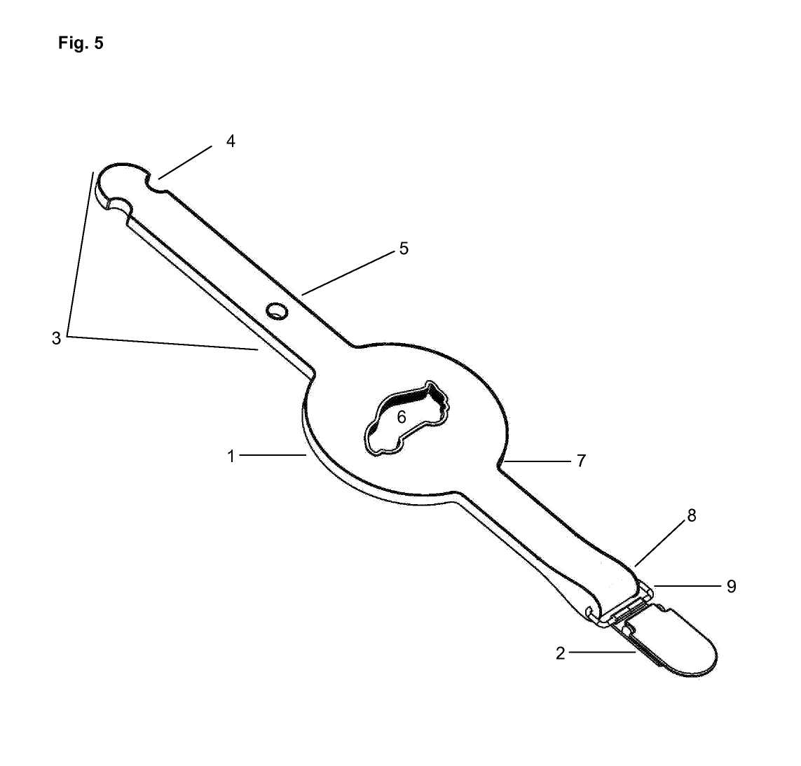

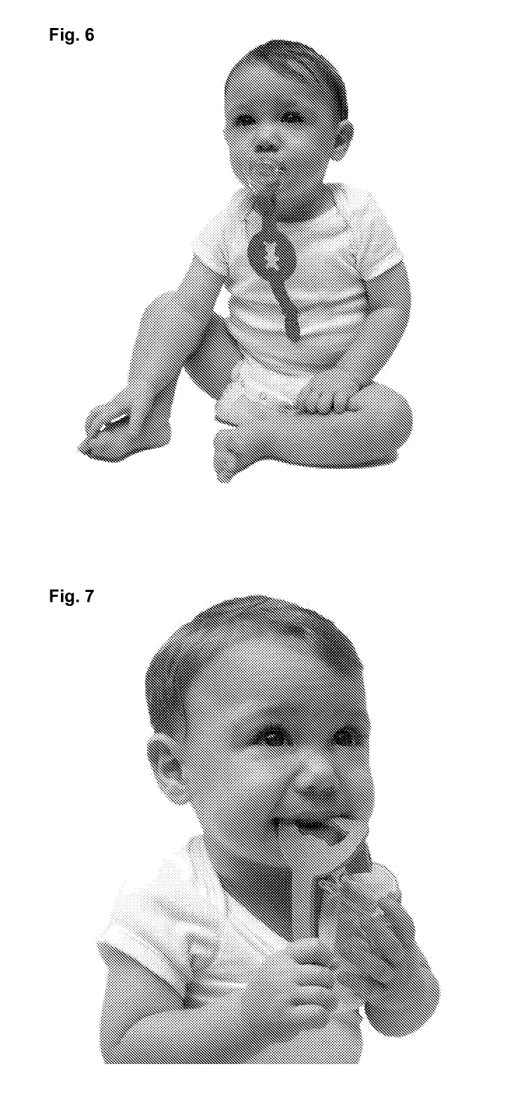

The preferred embodiment of the present inventions' pacifier-engaging end of the strap (4) is illustrated in FIG. 5, however, alternate embodiments may include, but are not limited other shapes, symbols or otherwise appropriate forms.

The preferred embodiment of the present inventions' connection hole (5) is circular as illustrated in FIG. 5, however, alternate embodiments may include, but are not limited other shapes, symbols or otherwise appropriate forms.

It is preferable that the strap (1) is constructed of a flexible and durable material that is purposeful to teething which includes but is not limited to silicone.

It is preferable that the strap (1) is constructed of a material that is non-toxic and safe for a child's mouth.

It is preferable that the method of production for the strap (1) includes but is not limited to mechanical or injection molding, laser or water jet cutting.

The strap (1) maybe a variety of colors or multicolored and include attractive decoration such as symbols, objects and shapes in the form of cut outs (6) or extrusions (7) that are pleasing to an infant or child preferably, but not necessary for effectiveness.

The preferred embodiment of the present invention includes additional textured surfaces on the strap (1) purposeful to teething including but not limited to cut outs (6) or extrusions (7) among other things.

The preferred embodiment of the clothing-engaging end (8) of the strap (1) is attached to a clip (2) having opposable jaws and a clamping mechanism that grip's the child's clothing thereby attaching the strap securely.

The preferred embodiment of the clip (2) is constructed of a durable material including but not limited to metal, plastic or polymer or a combination thereof.

The clip (2) can be covered or coated with another material for aesthetic or functional purposes including but not limited to paint or silicone among other things, preferably but not necessary for effectiveness.

In the present invention, the clip (2) is attached to the clothing-engaging end (8) of the strap (1) by inserting the top portion (9) of the clip (2) through the flexible and durable material of the strap (1).

Alternatively, the clip (2) can be attached to the clothing-engaging end (8) of the strap (1) by way of the flexible and durable strap material. For example, the clip (2) can be integrated into the clothing-engaging end (8) of the strap (1) by placing the clip (2) into the strap (1) mold prior to construction.

The invention claimed is:

1. A combination pacifier retaining strap and teething device that attaches to a child's clothing comprising:
A strap constructed of a durable and flexible material that is non-toxic and safe for a child's mouth,
A system for attaching a ring-style pacifier or pacifier with a connection hole integrated into the pacifier retaining teething strap, and
A clip that grin's the child's clothing thereby attaching the strap to said clothing.

2. A pacifier retaining teething strap that attaches to a child's clothing as claimed in claim 1, wherein the strap purposefully and intentionally itself, is and functions as a teething device.

3. A pacifier retaining teething strap that attaches to a child's clothing as claimed in claim 1, wherein the strap includes an integrated system for attaching a ring-style pacifier or pacifier with a connection hole at the pacifier-engaging end located at the top of the strap.

4. A pacifier retaining teething strap that attaches to a child's clothing as claimed in claim 1, wherein the strap maybe a variety of colors or multicolored and include attractive decoration such as symbols, objects and shapes in the form of cut outs or extrusions that are pleasing to an infant or child preferably, but not necessary for effectiveness.

5. A pacifier retaining teething strap that attaches to a child's clothing as claimed in claim 1, wherein the strap includes additional textured surfaces purposeful to teething.

6. A pacifier retaining teething strap that attaches to a child's clothing as claimed in claim 1, wherein the clothing-engaging end of the strap is attached to a clip having opposable jaws and a clamping mechanism that grip's the child's clothing thereby attaching the pacifier retaining teething strap securely.
